(19) United States
(12) Patent Application Publication
(10) Pub. No.: US 2018/0192502 A1
(43) Pub. Date: Jul. 5, 2018

(54) EMERGENCY LIGHTING SYSTEM

(71) Applicant: Barron Lighting Group, Glendale, AZ (US)

(72) Inventors: Henri Lozano, Surprise, AZ (US); Ajay Rao Goparaj, Peoria, AZ (US)

(21) Appl. No.: 15/857,801

(22) Filed: Dec. 29, 2017

Related U.S. Application Data
(60) Provisional application No. 62/440,218, filed on Dec. 29, 2016.

(51) Int. Cl. H05B 41/285; H02J 9/06; H05B 37/02; G08B 7/06; F21S 9/02; F21V 33/00; G08B 5/38

(52) U.S. Cl. CPC H05B 41/2853; H02J 9/065; H05B 37/02; F21Y 2115/10; F21S 9/022; F21V 33/0076; G08B 5/38; G08B 7/062

(57) ABSTRACT

The present invention relates generally to systems and methods for providing emergency lighting in an area. More specifically, the present invention relates to systems and methods for providing reliable power to emergency lighting, monitoring the emergency lighting to insure proper operation and function, and effective, efficient notification of users of status and error conditions of the emergency lighting.

### CROSS REFERENCE TO RELATED APPLICATION[S]

This application claims priority to U.S. Provisional Patent Application entitled “EMERGENCY LIGHTING SYSTEM,” Ser. No. 62/440,218, filed Dec. 29, 2016, the disclosure of which is hereby incorporated entirely herein by reference.

### TECHNICAL FIELD OF THE INVENTION

The present invention relates generally to systems and methods for providing emergency lighting in an area. More specifically, the present invention relates to systems and methods for providing reliable power to emergency lighting, monitoring the emergency lighting to insure proper operation and function, and effective, efficient notification of users of status and error conditions of the emergency lighting.

### BACKGROUND OF THE INVENTION

Many buildings and spaces include lighting systems to allow occupants and/or users of the spaces to be able to see items and objects in the spaces. Many of these lighting systems receive power from an electric power grid that provides alternating current (AC) power to users of the power grid. In the United States, this AC power is typically provided at an AC voltage of 110 or 220 VAC. In other countries, the provided voltage may have differing values. Lighting systems are typically hard-wired to receive the AC voltage and provide lighting within the space adjacent to the lighting systems.

In certain circumstances, power from the power grid may be interrupted. This may be a result of a natural disaster, overloading on the power grid, a catastrophic event at the lighting location (such as, for example, a fire), or other emergency situations. In order to avoid injury to those using lighted spaces and/or to allow the users of those spaces to continue to perform their duties effectively during an emergency, those responsible for providing lighting might desire to allow light to be provided during the emergency by means of emergency lighting systems. In certain cases, emergency lighting systems might continue to provide light by switching existing lights to an alternative power supply (such as, for example, a backup AC generator located on the premises), or by switching on alternate “emergency” lights that are powered by a different power source

It would be useful to provide an emergency lighting system and method including an integrated backup power supply that may be readily swapped out by users/monitors of the system even after the emergency lighting system is installed. It would also be useful to provide a monitoring system and method in which a user of the emergency lighting system could easily determine the status of the emergency lighting system to determine if it is functioning properly in both emergency and non-emergency situations.

### BRIEF DESCRIPTION OF THE DRAWINGS

A more complete understanding of the present invention may be derived by referring to the detailed description when considered in connection with the Figures (not necessarily drawn to scale), wherein like reference numbers refer to similar items throughout the Figures, and:

FIG. 1 generally illustrates a perspective view of a lighted space in which an Emergency Lighting System 100 is generally illustrated installed in a space in accordance with the teaching of an embodiment;

FIG. 2 generally illustrates a front side view of Emergency Lighting System 100 configured in accordance with an embodiment of the present invention;

FIG. 3 generally illustrates an additional front side view of Emergency Lighting System 100 configured in accordance with the embodiment of FIG. 2;

FIG. 4 generally illustrates an interior view of Emergency Lighting System 100 configured in accordance with the embodiment of FIG. 2;

FIG. 5 generally illustrates an interior view of Emergency Lighting System 100 configured in accordance with the embodiment of FIG. 2;

FIG. 6 generally illustrates an exploded view of the components of Emergency Lighting System 100 configured in accordance with the embodiment of FIG. 2; and,

FIG. 7 generally illustrates a schematic of components of Emergency Lighting System 100 configured in accordance with the embodiment of FIG. 2.

### DETAILED DESCRIPTION

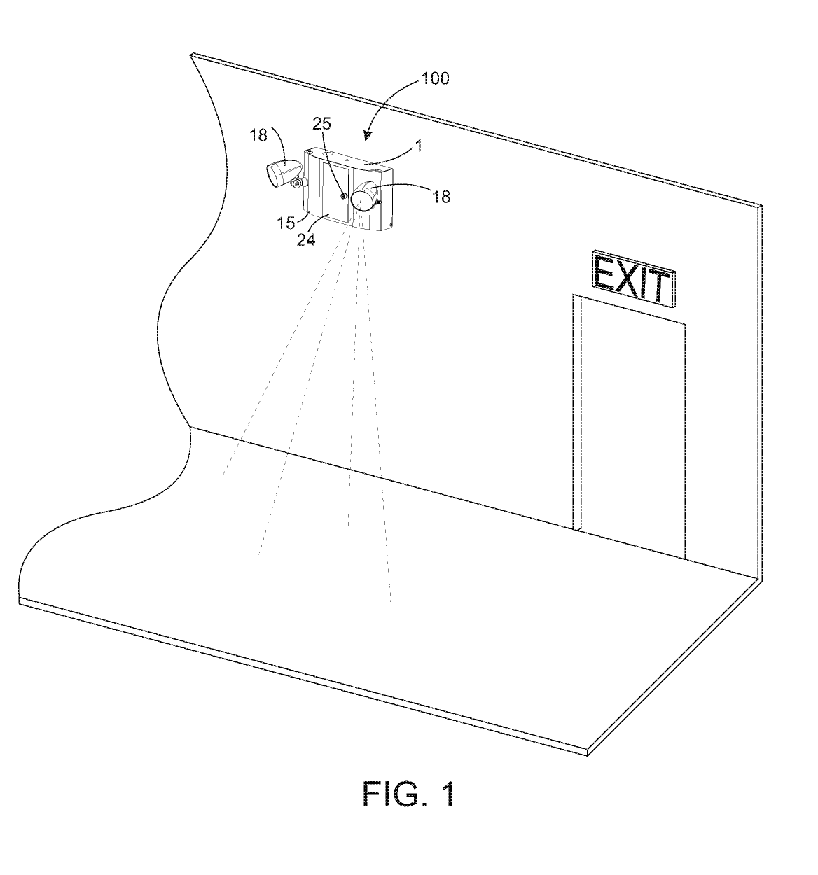

FIG. 1 generally illustrates a perspective view of a lighted space in which an Emergency Lighting System 100 is generally illustrated installed in a space in accordance with the teaching of an embodiment. As illustrated, Emergency Lighting System 100 is shown in an on-state in which two lights that are part of Emergency Lighting System 100 are turned on in order to illuminate an area adjacent to Emergency Lighting System 100. The lights of Emergency Lighting System 100 are directed such that they illuminate the area in order to assist occupants of the space to traverse through it safely on their way to an emergency exit. In the present embodiment, Emergency Lighting System 100 is shown having two lights for illuminating the space. It should be appreciated that in alternative embodiments, Emergency Lighting System 100 might have more or fewer lights.

In the present embodiment, each light of Emergency Lighting System 100 is configured such that it may be moved to direct its light to a specific portion of the area by users of Emergency Lighting System 100 to optimally illuminate a safe path to be traversed by occupants of the space. It should be appreciated that in alternative embodiments, all or some of the lights of Emergency Lighting System 100 may be fixed into position such that they are not movable. In the present embodiment, Emergency Lighting System 100 is shown located on a wall of the space at a height on the wall higher than the typical height of occupants of the space. It should be appreciated that in alternative embodiments, Emergency Lighting System 100 may be located at various heights on a wall of the space, on the ceiling of the space, or on other objects located in or on the space.

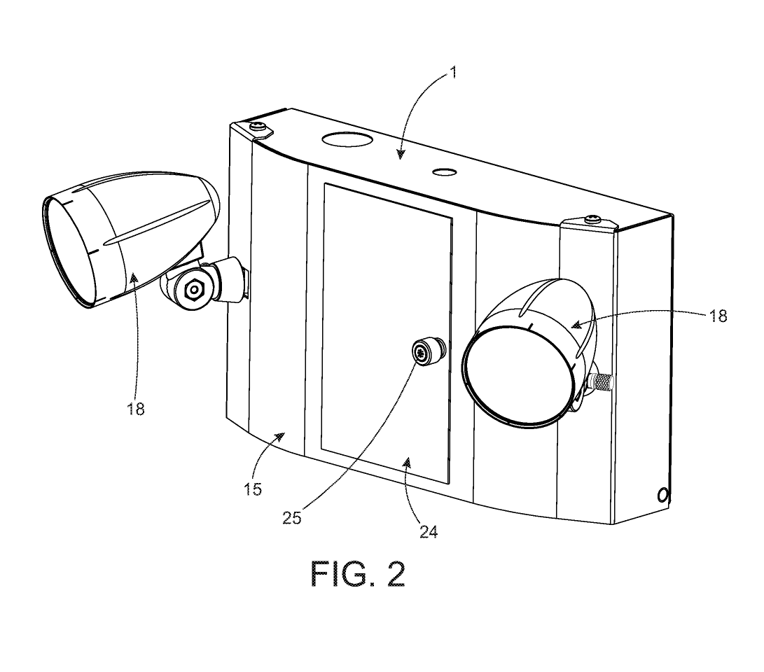

FIG. 2 generally illustrates a front side view of Emergency Lighting System 100 configured in accordance with an embodiment of the present invention. Emergency Lighting System 100 is shown comprising a Housing 1 for housing various components of the Emergency Lighting System 100. In the present embodiment, Housing 1 is made of metal. In alternative embodiments, Housing 1 may be made of other materials, such as, for example, plastic. Emergency Lighting System 100 is also shown comprising a Housing Cover 15 for securing and protecting the components housed in Housing 1. In the present embodiment, Housing Cover 15 is made of metal. In alternative embodiments, Housing Cover 15 may be made of other materials, such as, for example, plastic.

Emergency Lighting System 100 is further shown comprising Lights 18. As shown, Lights 18 each include 3 bulbs, and are secured to Housing Cover 15 such that each Light 18 can have the focus of its emitted light redirected both horizontally and vertically. In alternative embodiments, Lights 18 may have more or fewer bulbs. Emergency Lighting System 100 further comprises Auxiliary Power Supply Door 24 protecting an auxiliary power supply of Emergency Lighting System 100, and for providing access to an auxiliary power supply of Emergency Lighting System 100.

Auxiliary Power Supply Door 24 is shown having Lock 25 for securing Auxiliary Power Supply Door 24 in a closed position when Lock 25 is turned clockwise, and for allowing Auxiliary Power Supply Door 24 to be opened to provide access to an auxiliary power supply of Emergency Lighting System 100 when Lock 25 is turned counter-clockwise. It should be appreciated that in alternative embodiments, Auxiliary Power Supply Door 24 may have different shapes other than the shown rectangular shape, and that Lock 25 may take on other forms beyond a rotatable mechanism for securing Auxiliary Power Supply Door 24, including, for example, a latch mechanism, clips, or other means for securing Auxiliary Power Supply Door 24 in a closed position.

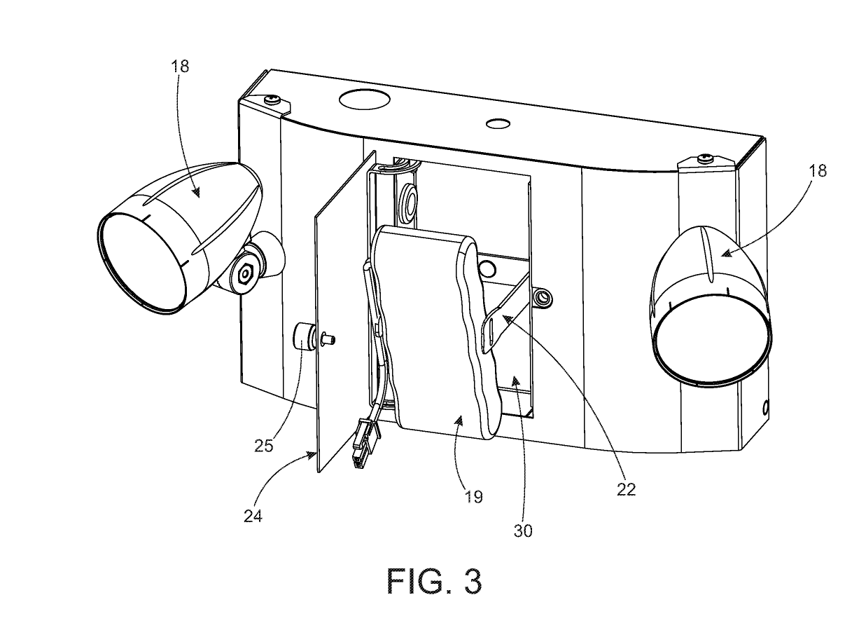

FIG. 3 generally illustrates an additional front side view of Emergency Lighting System 100 configured in accordance with the embodiment of FIG. 2. FIG. 3 is essentially identical to FIG. 2, with the exception that the Auxiliary Power Supply Door 24 is shown in the “open” position, revealing Auxiliary Power Supply Compartment 30, Auxiliary Power Supply 19, Auxiliary Power Supply Retention Device 22, and additional detail about Auxiliary Power Supply Door 24. As shown, an edge of Auxiliary Power Supply Door 24 is rotatably secured to Housing Cover 15 by means of hinges that permit Auxiliary Power Supply Door 24 to swing open outwardly along an edge of Auxiliary Power Supply Door 24 when Lock 25 is turned counter-clockwise, and such that Auxiliary Power Supply Compartment 30 is covered by Auxiliary Power Supply Door 24 when Auxiliary Power Supply Door 24 is rotated to the closed position. In alternative embodiments, Auxiliary Power Supply Door 24 may be rotatably or removably secured to Housing Cover 15 by other means known in the art.

FIG. 3 also generally illustrates Auxiliary Power Supply 19 and a removable electrical connector configured to couple Auxiliary Power Supply 19 electrically to components of Emergency Lighting System 100 located within Housing 1 when the removable electrical connector is connected to circuitry of Emergency Lighting System 100. In the present embodiment, Auxiliary Power Supply 19 is a rechargeable battery pack. In alternative embodiments, Auxiliary Power Supply 19 may be other removable power sources. FIG. 3 also generally illustrates Auxiliary Power Supply Retention Device 22 which is configured to securely retain Auxiliary Power Supply 19 within the recess of Auxiliary Power Supply Compartment 30. In the present embodiment, Auxiliary Power Supply Retention Device 22 is a clip retention mechanism. In alternative embodiments, Auxiliary Power Supply Retention Device 22 may include other means of securing Auxiliary Power Supply 19 within Auxiliary Power Supply Compartment 30, such as, for example, Velcro, straps, or other securing means.

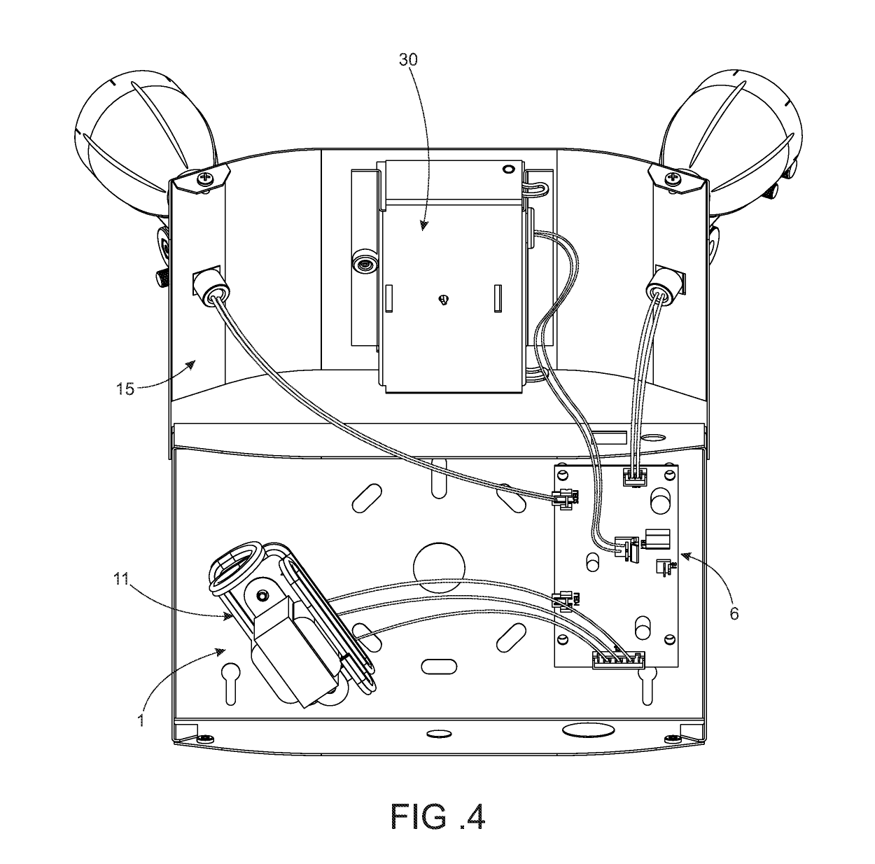

FIG. 4 generally illustrates an interior view of Emergency Lighting System 100 configured in accordance with the embodiment of FIG. 2. FIG. 4 shows a rear-view of Auxiliary Power Supply Compartment 30, and the electrical connection from Auxiliary Power Supply 19 (not shown) to Control Board 6 via the removable connector discussed previously. Control Board 6 is configured to monitor various aspects of the performance of Emergency Lighting System 100 and provide information external to Emergency Lighting System 100 indicative of the state, condition and functionality of Emergency Lighting System 100. As is generally illustrated in FIG. 4 (and FIGS. 3, 5 and 6), Auxiliary Power Supply Compartment 30 is configured such that its interior, and the Auxiliary Power Supply 19 contained therein, are substantially physically isolated from other components and circuitry located within Housing 1 and behind or adjacent to the exterior of Auxiliary Power Supply Compartment 30. Furthermore, as shown, Transformer 100, and the AC power mains connected thereto, are completely physically and electrically isolated from the interior of Auxiliary Power Supply Compartment 30 by the walls of Auxiliary Power Supply Compartment 30.

Control Board 6 is further shown electrically coupled to Lights 18. Control Board 6 is configured to provide power to Lights 18 and control the charging and discharging of Auxiliary Power Supply 19, and control other aspects of Emergency Lighting System 100 as will be discussed further below. FIG. 4 further illustrates a Transformer 11 electrically coupled to AC power mains (not shown) for providing main power to Emergency Lighting System 100, and is also shown electrically coupled to Control Board 6 for providing power to Control Board 6 and Auxiliary Power Supply 19 responsive to Control Board 6.

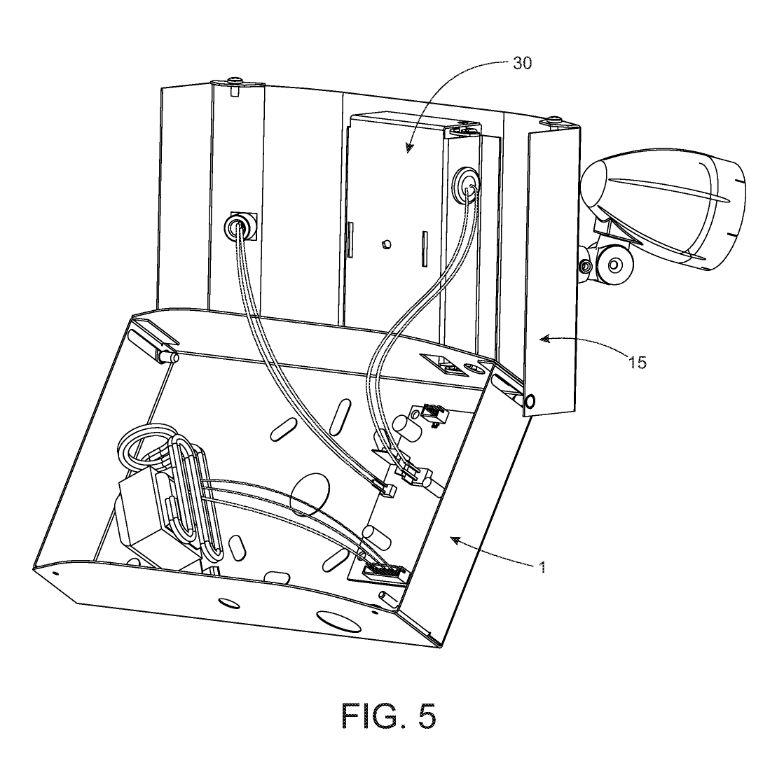

FIG. 5 generally illustrates an additional interior view of Emergency Lighting System 100 configured in accordance with the embodiment of FIG. 2. The elements generally illustrated in FIG. 5 are the same as those previously discussed with respect to FIG. 4, but are provided at a different angle for an additional perspective.

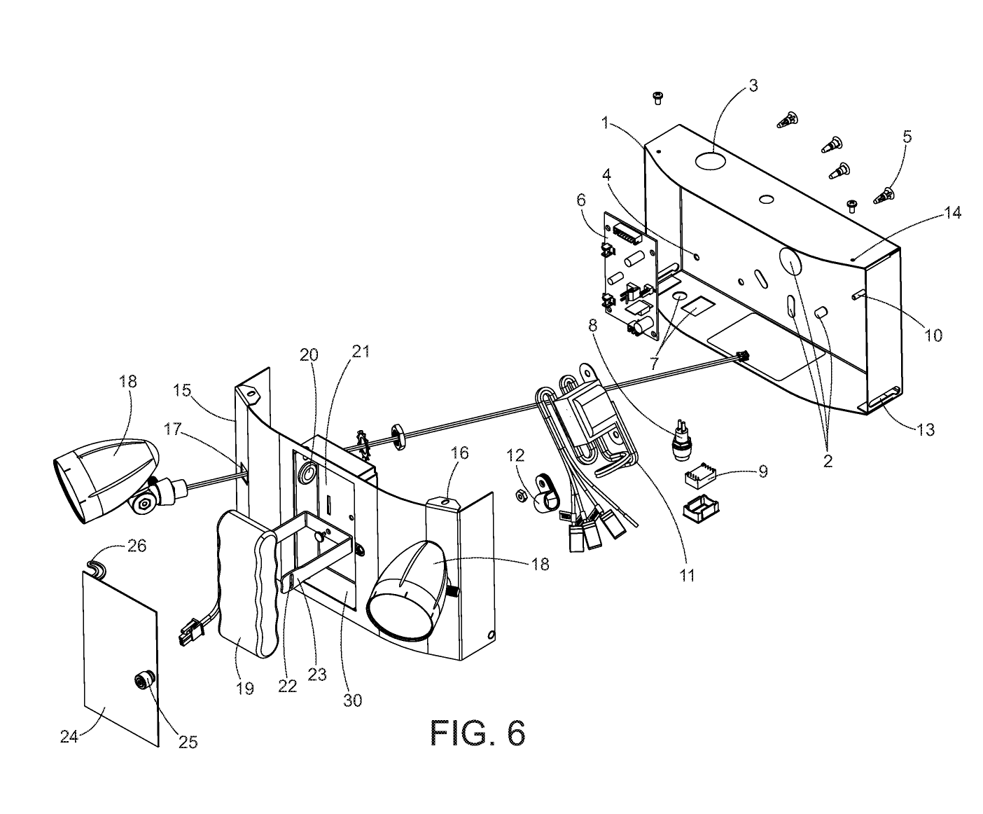

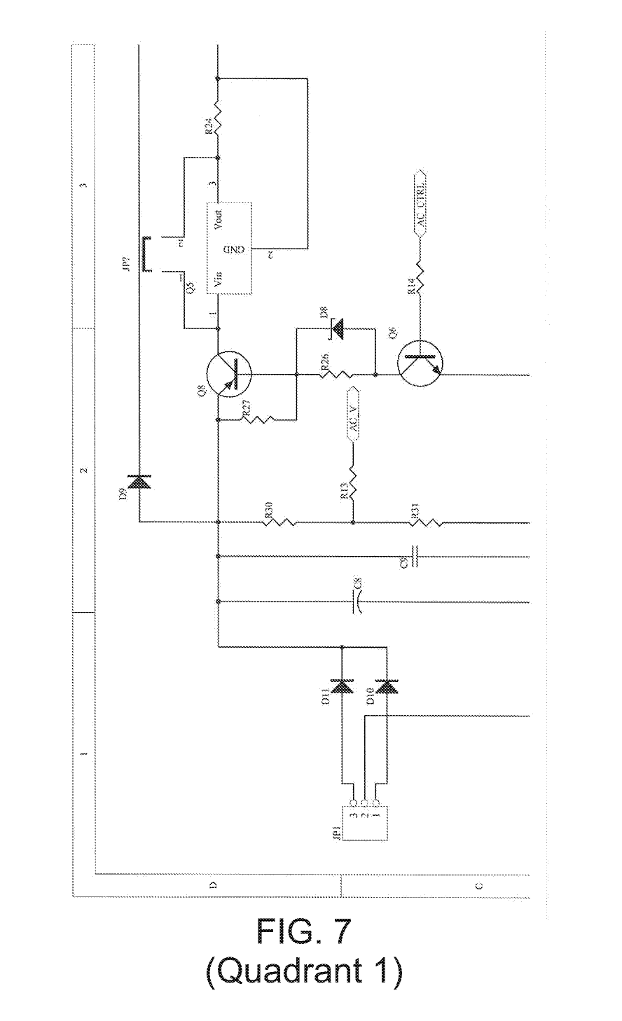

FIG. 6 generally illustrates an exploded view of the components of Emergency Lighting System 100 configured in accordance with the embodiment of FIG. 2. Emergency Lighting System 100 comprises Transformer 11 located within Housing 1, and configured to be electrically coupled to AC power mains (not shown). Transformer 11 is configured to convert the AC voltage provided by the AC power mains (not shown) into a lower AC voltage. Transformer 11 has its outputs electrically coupled to Control Board 6 such that circuitry of Control Board 6 provides DC voltage and current to the remaining circuitry of Control Board 6, as is discussed further below. Emergency Lighting System 100 further comprises Control Board 6. Control Board 6 includes electronic circuitry configured to control the operation of Emergency Lighting System 100, monitor the status and state of Emergency Lighting System 100, and provide power to lights of Emergency Lighting System 100. Control Board 6 will be described more specifically below.

Emergency Lighting System 100 further comprises Auxiliary Power Supply 19, which is removably secured within Auxiliary Power Supply Compartment 30 by means of Auxiliary Power Supply Retention Device 22. Auxiliary Power Supply 19 is further removably electrically connected to Control Board 6 by means of an electrical cable.

Auxiliary Power Supply 19 and the connecting cable are configured such that when the electrical cable is removed and Auxiliary Power Supply 19 is released by Auxiliary Power Supply Retention Device 22, Auxiliary Power Supply 19 may be removed from Emergency Lighting System 100 and replaced by another Auxiliary Power Supply 19 by connecting the electrical cable and securing the new Auxiliary Power Supply 19 with Auxiliary Power Supply Retention Device 22. Emergency Lighting System 100 further comprises Lights 18 electrically coupled to Control Board 6. In the present embodiment, each Light 18 includes three bulbs, and is configured to be movable such that the focus of each Light 18 can be directed to provide light in the desired area. Control Board 6 is configured to control the power provided to the Lights 18 to determine when they are illuminated and the intensity of illumination.

Emergency Lighting System 100 further comprises Display 9 electrically coupled to Control Board 6. In the present embodiment, Display 9 is an alphanumeric display configured to display letters and/or numbers based on output signals provided by Control Board 6. Emergency Lighting System 100 further comprises Auxiliary Power Supply Door 24 secured to Housing Cover 15 such that Auxiliary Power Supply Door 24 may be opened and closed by a user to provide easy access to Auxiliary Power Supply 19.

In the present embodiment, Auxiliary Power Supply Door 24 is secured to Housing Cover 15 by hinges that allow Auxiliary Power Supply Door 24 to rotate along an edge of Auxiliary Power Supply Door 24 to provide access to Auxiliary Power Supply 19. In an alternative embodiment, Auxiliary Power Supply Door 24 may be configured so that it may be completely removed to provide access to Auxiliary Power Supply 19. In the closed position, Auxiliary Power Supply Door 24 prevents access to Auxiliary Power Supply 19 and protects it from external debris. Auxiliary Power Supply Door 24 includes Lock 25 for securing Auxiliary Power Supply Door 24 in a closed position. In the present embodiment, Lock 25 is a screw latch that allows Auxiliary Power Supply Door 24 to open when it is rotated counterclockwise, and secures Auxiliary Power Supply Door 24 in a closed position when rotated clockwise.

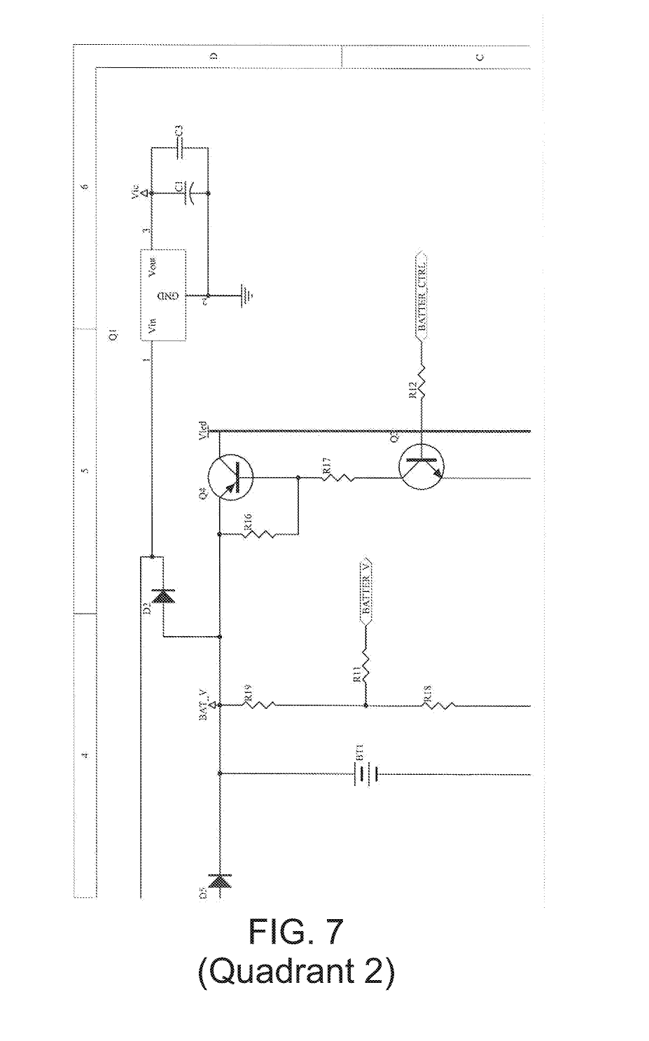

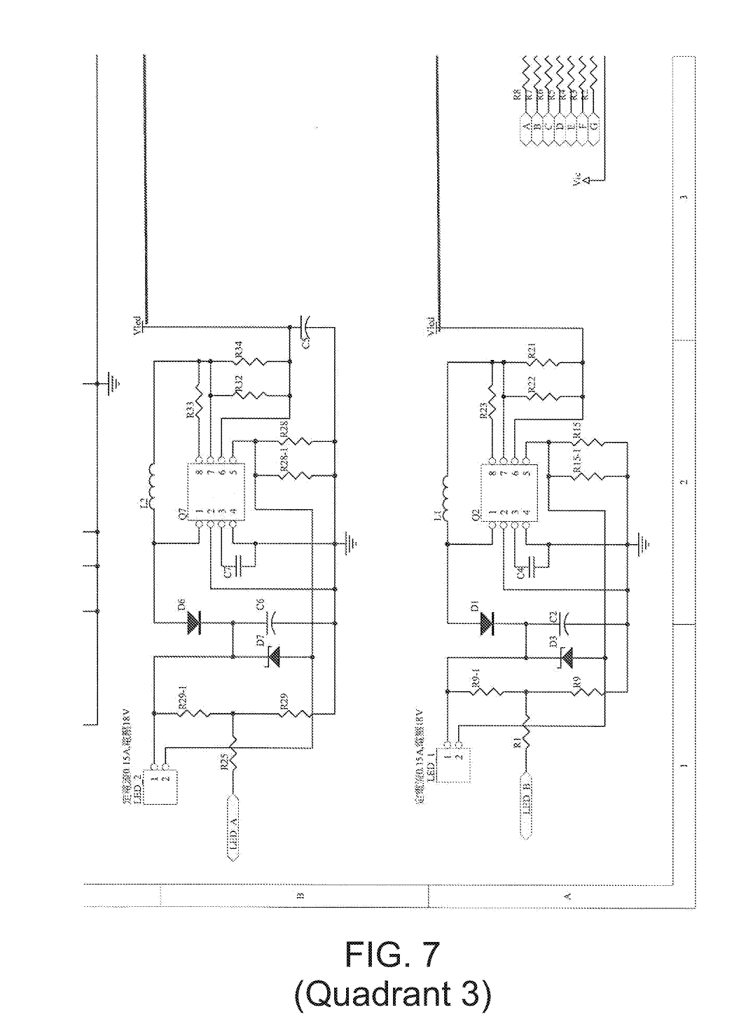

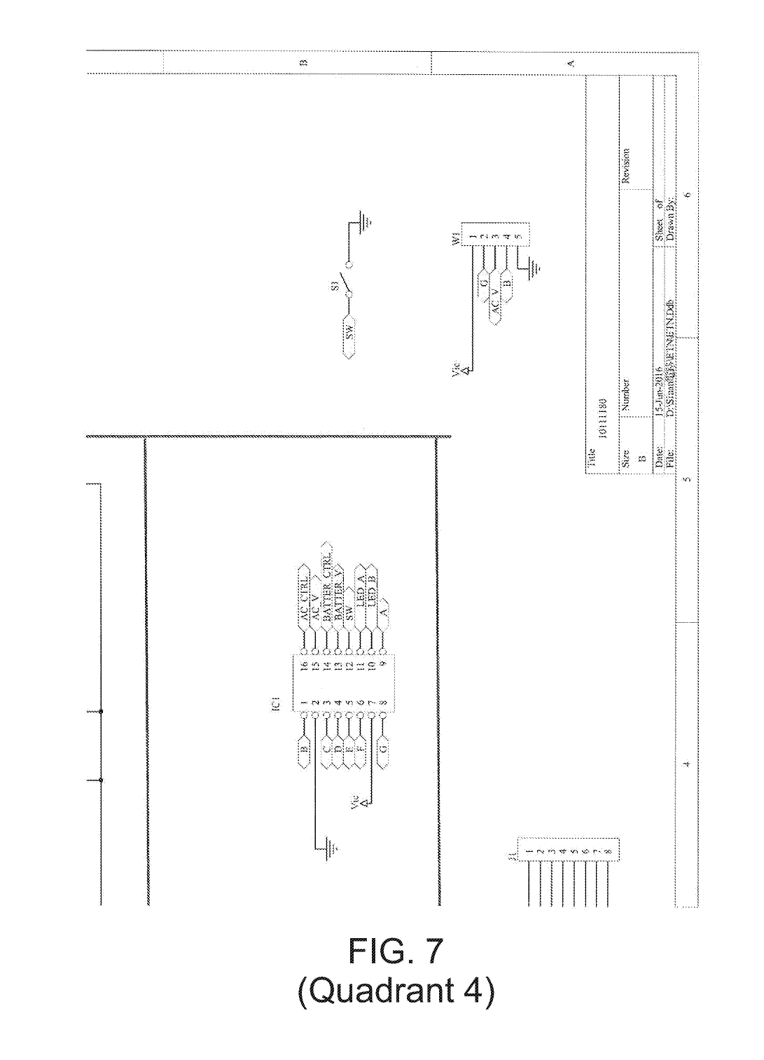

FIG. 7 generally illustrates a schematic of components of Emergency Lighting System 100 configured in accordance with the embodiment of FIG. 2. More specifically, FIG. 7 primarily illustrates key components and interconnections among components of Control Board 6. Key components of the present embodiment, along with their operation, will be discussed with reference primarily to FIG. 7, and to the previous figures. As previously noted, AC main supply voltage is supplied to Emergency Lighting System 100 at Transformer 11. More specifically, AC power from the mains is connected to the primary winding of Transformer 11, and is stepped down by Transformer 11 to a lower AC voltage at the output of the secondary winding of Transformer 11. This lower AC voltage enters the circuitry of Control Board 6 at the left hand side of FIG. 7 at JP1.

The supplied lower AC voltage provided at the secondary winding of Transformer 11 is sensed using the voltage divider network (R30 and R31) by providing the output of the voltage divider network via R13 (referred to hereinafter as AC_V) to pin 15 of Integrated Circuit 1. In the present embodiment, Integrated Circuit 1 is a Holtek HT66F20-1 microcontroller including processing circuitry, memory, and I/O functionality. A full wave diode rectifier D10 and D11 converts the lower AC voltage provided at the secondary winding of Transformer 11 to a DC voltage (referred to as VDC). Capacitors C8 and C9 are used to smooth the DC voltage (referred to as SVDC) obtained from the diode rectifier D10 and D11. SVDC is then available to charge Auxiliary Power Supply 19 as discussed below.

Control Board 6 further includes a battery charging circuit configured to charge Auxiliary Power Supply 19 under the control of Integrated Circuit 1. The battery charging circuit comprises a voltage regulator, transistor Q5, and transistors Q8 and Q6. The battery charging circuit receives SVDC from the smoothing and rectifier section of Control Board 6 (discussed above), and processes the SVDC signal to provide a constant current charging voltage to Auxiliary Power Supply 19 at BAT_V when the battery charging circuit is enabled by Integrated Circuit 1. The battery charging circuit is enabled when Integrated Circuit 1 provides an output signal (referred to as AC_CTRL) at pin 16. This AC_CTRL signal, which is electrically coupled to the transistor Q6, serves to turn transistor Q6 (and the battery charging circuit) on, providing the constant charging current to Auxiliary Power Supply 19.

Control Board 6 further includes monitoring circuitry to monitor the charge level of Auxiliary Power Supply 19 to determine if Auxiliary Power Supply 19 is fully charged or partially discharged. As noted previously, Auxiliary Power Supply 19 is electrically coupled to Control Board 6 at BAT_V. The voltage level of BAT_V is provided to pin 13 of Integrated Circuit 1 as signal BATTER_V, which is the output of the voltage divider network R19 and R18 as provided via R11. When Integrated Circuit 1, monitoring the signal BATTER_V, determines that Auxiliary Power Supply 19 is fully charged (a voltage of approximately 6.8V), the battery charge is disabled by the AC_CTRL signal provided from Integrated Circuit 1 to the battery charging circuit. When Integrated Circuit 1, monitoring BATTER_V, determines that the battery voltage has fallen below 6.8V, the battery charging circuit is turned on again via the AC_CTRL signal from Integrated Circuit 1.

Control Board 6 further includes circuitry to monitor the AC voltage provided to Control Board 6, determine when it is too low, and enable Lights 18 to turn on when the AC voltage is not present, or is too low. More specifically, as noted above, AC_V is provided to Integrated Circuit 1 via pin 15. When AC_V falls below a specified value, Integrated Circuit 1 causes pin 14 (BATTER_CTRL) to change to a state that causes transistor Q3 to turn on. This results in transistor Q4 providing voltage and current from Auxiliary Power Supply 19 to provide power to Lights 18, turning them on and providing illumination.

Control Board 6 further includes lamp driver circuity for each of Lights 18, electrically coupled to transistor Q4 and generally illustrated in the lower left-hand portion of FIG. 7. The lamp driver circuitry is configured to receive power from Auxiliary Power Supply 19 as discussed above, and to cause Lights 18 to turn on. The lamp driver circuitry for the first Light 18 provides a signal, LED A, electrically coupled to pin 11 of Integrated Circuit 1, and configured to provide to Integrated Circuit 1 the a voltage associated with the operation of the first Light 18. The lamp driver circuitry for the second Light 18 provides a signal, LED B, electrically coupled to pin 10 of Integrated Circuit 1, and configured to provide to Integrated Circuit 1 the a voltage associated with the operation of the second Light 18.

Control Board 6 further includes Display 9. Display 9 is electrically coupled to Integrated Circuit 1, and configured to receive signals from Integrated Circuit 1 to drive the Display 9 to display alpha-numeric characters. In the present embodiment, Display 9 is electrically coupled to Integrated Circuit 1 through resistors via a jumper J1. In the present embodiment, Integrated Circuit 1 provides output signals at various of pins 9, 1, 3-6 and 8 to drive individual segments of Display 9, causing Display 9 (depending on the values of those pins) to display various characters and/or numbers. Integrated Circuit 1 is configured to monitor various signals and states of Emergency Lighting System 100, and to display various alpha-numeric characters via Display 9 based on that information and various determinations made by Integrated Circuit 1. In the present embodiment, each alpha-numeric code is configured to communicate to a user/viewer of Emergency Lighting System 100 information about the Emergency Lighting System 100.

Referring collectively to FIGS. 1-7, the operation of the Emergency Lighting System 100 will be described, according to an embodiment of the invention. In a typical state of operation, Emergency Lighting System 100 will be receiving AC power from power mains. Emergency Lighting System 100 monitors the status and charge of the Auxiliary Power Supply 19 (BAT_V) in Integrated Circuit 1 via the BATTER_V signal. In the present embodiment, Auxiliary Power Supply 19 is fully charged when Auxiliary Power Supply 19 (BAT_V) has a voltage of 6.8 volts or greater. In the present embodiment, when BAT_V has a voltage of 6.8 volts, BATTER_V has a voltage 1.19 Volts. Thus, Integrated Circuit 1 is configured to determine if BATTER_V is 1.19 Volts or greater. If BATTER_V is 1.19 Volts or greater, Integrated Circuit 1 determines that Auxiliary Power Supply 19 is fully charged, and turns off the charging circuit (or leaves it off it is already off) by means of the AC_CTRL signal. In addition, in order to effectively communicate to users of Emergency Lighting System 100 that Auxiliary Power Supply 19 is fully charged, Integrated Circuit 1 drives the outputs of pins 9, 1, 3-6 and 8 to display, on Display 9, the code “0”, indicative of a fully charged Auxiliary Power Supply 19.

If Integrated Circuit 1 determines that BATTER_V has a value between 0.877 Volts and 1.19 Volts (indicative, in the present embodiment, of a BAT_V voltage of Auxiliary Power Supply 19 of between approximately 5 Volts and 6.8 Volts), Integrated Circuit 1 determines that Auxiliary Power Supply 19 is not fully charged, and that Emergency Lighting System 100 is in a “battery charging” state. In this case, Integrated Circuit 1 also turns on the charging circuit (if it is not already on) or leaves it on (if it is already on) by means of the AC_CTRL signal. In addition, in order to effectively communicate to users of Emergency Lighting System 100 that Auxiliary Power Supply 19 is not fully charged, and that Emergency Lighting System 100 is in a “battery charging” state, Integrated Circuit 1 drives the outputs of Integrated Circuit 1 pins 9, 1, 3-6 and 8 to display, on Display 9, the code 1, indicative to users of a “battery charging” state.

If Integrated Circuit 1 determines that AC_V (pin 15 of Integrated Circuit 1) has a value of less than approximately 0.351 Volts (which corresponds, in the present embodiment, of voltage of less than approximately 30V at the secondary winding of Transformer 11), Integrated Circuit 1 determines that Emergency Lighting System 100 is in “Emergency/Battery” mode. When in Emergency/Battery mode, Integrated Circuit 1 causes pin 14 (BATTER_CTRL) to switch to a level to cause Lights 18 to turn on, the Lights 18 being powered by Auxiliary Power Supply 19. In addition, Integrated Circuit 1 causes Integrated Circuit 1 pins 9, 1, 3-6 and 8 to display, on Display 9, the code 2, indicative to users that Emergency Lighting System 100 is in Emergency/Battery mode. Once Integrated Circuit 1 determines that AC_V no longer has a value of less than approximately 0.351 Volts, Integrated Circuit 1 causes Emergency Lighting System 100 to enter one of the other modes and display the appropriate mode code on Display 9.

If Integrated Circuit 1 determines that Auxiliary Power Supply 19 has been disconnected or shorted, or the charging circuitry has failed, Integrated Circuit 1 causes Integrated Circuit 1 pins 9, 1, 3-6 and 8 to display, on Display 9, the code 3. In an embodiment, Integrated Circuit 1 determines that Auxiliary Power Supply 19 has been disconnected or shorted, or that the charging circuitry has failed, by monitoring pin 11 (LED A) of Integrated Circuit 1 and determining that the voltage at pin 11 (LED A) is between approximately 0 and 1.25V. In an alternative embodiment, Integrated Circuit 1 determines that Auxiliary Power supply 19 has been disconnected or shorted, or that the charging circuitry has failed, by monitoring pin 10 (LED B) of Integrated Circuit 1 in a manner similar to the monitoring of pin 11.

If Integrated Circuit 1 determines that BATTER_V voltage is between approximately 0 and 0.526V (corresponding to a BAT_V voltage of between approximately 0 and 3 volts), Integrated Circuit 1 determines that Auxiliary Power Supply 19 is connected, but is bad, and causes Integrated Circuit 1 pins 9, 1, 3-6 and 8 to display, on Display 9, the code 4. If the user sees a code 4 displayed, the Auxiliary Power Supply 19 should be replaced.

Integrated Circuit 1 is further configured to monitor the signals LED A and LED B (via pins 11 and 10, respectively, of Integrated Circuit 1), indicative of voltages of Lights 18. If the voltage of LED A or LED B is greater than approximately 3.6V, Integrated Circuit 1 determines that at least one of the Lights 18s has failed, and causes Integrated Circuit 1 pins 9, 1, 3-6 and 8 to display, on Display 9, the code 5, indicative to a user of Emergency Lighting System 100 of a lamp failure.

If Integrated Circuit 1 determines that BATTER_V is between approximately 0.526 volts and 0.877 volts, indicative of a BAT_V (Auxiliary Power Supply 19) voltage of approximately 3-5 volts, Integrated Circuit 1 determines that the voltage of Auxiliary Power Supply 19 is low, and causes Integrated Circuit 1 pins 9, 1, 3-6 and 8 to display, on Display 9, the code 6 indicative of low Auxiliary Power Supply 19 voltage. Integrated Circuit 1 further causes Emergency Lighting System 100 to remain in, or enter, a charging mode to charge Auxiliary Power Supply 19.

It should be appreciated that in alternative embodiments, Integrated Circuit 1 may be configured to cause the alpha-numeric characters displayed on Display 9 to flash on and off. In addition, although the current embodiment provides approximate voltage ranges required for Emergency Lighting System 100 to enter various states and display various codes, it should be appreciated that in alternative embodiments, Emergency Lighting System 100 could be configured to enter various states (and display various codes) based on voltage and/or current threshold values other than those of the present embodiment.

Although the preferred embodiments of the invention have been illustrated and described, it will be readily apparent to those skilled in the art that various modifications may be made therein without departing from the spirit of the invention or from the scope of the appended claims.

What is claimed is:

1. An emergency lighting system comprising:
a housing configured to house various components of the emergency lighting system;
at least one light secured to said housing, said at least on light configured to be movable such that the focus of its emitted light may be redirected in various directions;
an auxiliary power supply removably secured within said housing and electrically coupled to control circuitry housed within the emergency lighting system;
a transformer electrically coupled to AC power mains and to the control circuitry, said transformer configured to step down the voltage of the AC power mains before providing it to the control circuitry, wherein said control circuitry is configured to convert the stepped down AC voltage to DC, provide DC charging voltage to the auxiliary power supply, provide power to illuminate the at least one light, monitor the status of the emergency lighting system, and provide output signals indicative of the status of the emergency lighting system; and,
an alphanumeric display electrically coupled to the control circuitry and configured to display an alphanumeric character code received from the control circuitry indicative of the status of the emergency lighting system.

2. The emergency lighting system of claim 1, wherein the status monitored includes a charging state of the auxiliary power supply.

3. The emergency lighting system of claim 1, wherein the status monitored includes an illumination intensity of the at least one light.

4. The emergency lighting system of claim 1, wherein the status monitored includes at least one of a bad auxiliary power supply, auxiliary power supply disconnected, short circuit, or charging circuit failure.

5. The emergency lighting system of claim 1, wherein the status monitored includes a light failure.

6. The emergency lighting system of claim 2, wherein the alphanumeric character code is indicative of a charging state of the auxiliary power supply.

7. The emergency lighting system of claim 3, wherein the alphanumeric character code is indicative of an illumination intensity of the at least one light.

8. The emergency lighting system of claim 4, wherein the alphanumeric character code is indicative of at least one of a bad auxiliary power supply, auxiliary power supply disconnected, short circuit, or charging circuit failure.

9. The emergency lighting system of claim 5, wherein the alphanumeric character code is indicative of a light failure.

10. The emergency lighting system of claim 1, further comprising an auxiliary power supply compartment within said housing, wherein the interior of said auxiliary power supply compartment is substantially physically isolated from the control circuitry, AC power mains, and transformer, and wherein the auxiliary power supply is removably located within the auxiliary power supply compartment.

11. The emergency lighting system of claim 10, further comprising a cover removably secured to said housing and configured to provide access to the auxiliary power supply within said auxiliary power supply compartment.

12. The emergency lighting system of claim 11, wherein said cover is configured to lock into place.

13. A method for providing emergency lighting, comprising the steps of:
providing a housing having AC power, control circuitry, at least one light, an auxiliary power supply located within the housing and substantially physically isolated from the AC Power and control circuitry, and an alphanumeric display;
monitoring in the control circuitry the operational status of the emergency lighting system; and,
displaying, on the alphanumeric display, an alphanumeric code indicative of the operational status of the emergency lighting system.

14. The method of claim 13, wherein the operational status monitored and displayed is the charge state of the auxiliary power supply.

15. The method of claim 13, wherein the operational status monitored and displayed is the intensity of the output of the light.

16. The method of claim 13, wherein the operational status monitored and displayed is a failure of the light.

17. The method of claim 13, wherein the operational status monitored and displayed is indicative of the emergency lighting system operating using the auxiliary power supply for power.

18. An emergency lighting system comprising:
a housing configured to be positioned in an interior space of a structure, and further configured to house various components of the emergency lighting system;
a housing cover securable to said housing, and configured to secure and protect said components;
at least one light secured to the exterior of said housing, said at least on light configured to be movable such that the focus of its emitted light may be redirected to various location in the interior space of the structure;
an auxiliary power supply compartment positioned within said housing, and configured to contain an auxiliary power supply, wherein the interior of said auxiliary power supply compartment is substantially isolated from high voltage areas of the emergency lighting system;
an auxiliary power supply door removably secured to said housing and configured to provide access to an auxiliary power supply contained within said auxiliary power supply compartment, said auxiliary power supply door having a locking mechanism for securing said auxiliary power supply door in a closed position;
an auxiliary power supply retention device located within said auxiliary power supply compartment and configured to removably secure an auxiliary power supply in said auxiliary power supply compartment;
an auxiliary power supply removably secured by said auxiliary power supply retention device within said auxiliary power supply compartment and electrically coupled to control circuitry housed within the emergency lighting system;
a transformer electrically coupled to AC power mains and to the control circuitry, said transformer configured to step down the voltage of the AC power mains before providing it to the control circuitry, wherein said control circuitry is configured to convert the stepped down AC voltage to DC, provide DC charging voltage to the auxiliary power supply, provide power to illuminate the light, monitor the status of the emergency lighting system, and provide output signals indicative of the status of the emergency lighting system; and,
an alphanumeric display electrically coupled to the control circuitry and configured to display an alphanumeric character code indicative of the status of the emergency lighting system.
